(19) United States
(12) Patent Application Publication
(10) Pub. No.: US 2021/0142163 A1
(43) Pub. Date: May 13, 2021

(54) Data Padding Method and Data Padding System Thereof

(71) Applicant: U-MEDIA Communications, Inc., Hsinchu (TW)

(72) Inventor: Li-Chung Wang, Taipei City (TW)

(21) Appl. No.: 16/708,333

(22) Filed: Dec. 9, 2019

(30) Foreign Application Priority Data
Nov. 12, 2019 (TW) 108141024

(51) Int. Cl. G06N 3/08

(52) U.S. Cl. CPC G06N 3/08

(57) ABSTRACT

A data padding method includes adding at least one padding column or at least one padding row to a data matrix. One of a plurality of elements of the at least one padding row or the at least one padding column is different from another of the plurality of elements.

### BACKGROUND OF THE INVENTION

### 1. Field of the Invention

The present invention relates to a data padding method and a data padding system, and more particularly, to a data padding method and a data padding system capable of improving inference accuracy of neural network in deep learning.

### 2. Description of the Prior Art

In deep learning technology, a neural network may contain a set of neurons and may have corresponding structure or function in a biological neural network. Neural networks may provide useful techniques for a variety of applications, particularly for audio processing applications. For example, Convolutional Neural Networks (CNN) may be utilized for voice recognition or sound event detection. However, the current padding method for the convolution operation of a spectrogram is padding zero or no padding, which causes feature extraction errors or feature loss and affects inference accuracy.

### SUMMARY OF THE INVENTION

It is therefore a primary objective of the present application to provide a data padding method and a data padding system capable of improving inference accuracy of neural network in deep learning.

The present invention discloses a data padding method. The data padding method includes adding at least one padding column or at least one padding row to a data matrix, wherein one of a plurality of elements of the at least one padding column or the at least one padding row is different from another of the plurality of elements.

The present invention further discloses a data padding system. The data padding system includes a storage circuit and a processing circuit. The storage circuit is utilized for storing an instruction. The instruction includes adding at least one padding column or at least one padding row to a data matrix, wherein one of a plurality of elements of the at least one padding column or the at least one padding row is different from another of the plurality of elements. The processing circuit is coupled to the storage circuit, and utilized for executing the instruction stored in the storage circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a data padding system according to an embodiment of the present invention.

FIG. 2 is a schematic diagram of a data padding method according to an embodiment of the present invention.

FIG. 2 is according to an embodiment of the present invention a data padding method of process diagram.

FIG. 3 is a schematic diagram of a data matrix, padding columns, padding rows and convolution operation thereof according to an embodiment of the present invention.

FIG. 4 is a schematic diagram of conversion of an audio data, padding data into the data matrix and the padding columns as shown in FIG. 3 according to an embodiment of the present invention.

FIG. 5 is a schematic diagram of an audio data, padding data, and the audio data and the padding data shown in FIG. 4 according to an embodiment of the present invention.

FIG. 6 is a schematic diagram of an audio data and the audio data and the padding data shown in FIG. 4 according to an embodiment of the present invention.

FIG. 7 is a schematic diagram of conversion of the audio data shown in FIG. 4 into the data matrix shown in FIG. 3 and a padding row according to an embodiment of the present invention.

FIG. 8 is a schematic diagram of conversion of the audio data shown in FIG. 4 into the data matrix shown in FIG. 3 and a padding row according to an embodiment of the present invention.

FIG. 9 is a schematic diagram of conversion of the audio data shown in FIG. 4 into the data array shown in FIG. 3 and a padding row according to an embodiment of the present invention.

FIG. 10 is a schematic diagram of conversion of the audio data shown in FIG. 4 into the data matrix shown in FIG. 3 and a padding row according to an embodiment of the present invention.

### DETAILED DESCRIPTION

In the following description and claims, the terms “include” and “comprise” are used in an open-ended fashion, and thus should be interpreted to mean “include, but not limited to”. Use of ordinal terms such as “first” and “second” does not by itself connote any priority, precedence, or order of one element over another or the temporal order in which acts of a method are performed, but are used merely as labels to distinguish one element having a certain name from another element having the same name.

Please refer to FIG. 1, which is a schematic diagram of a data padding system 10 according to an embodiment of the present invention. The data padding system 10 is utilized for processing data such as performing data padding. The data padding system 10 includes a processing circuit 150 and a storage circuit 160. The processing circuit 150 may be a Central Processing Unit (CPU), a microprocessor, or an Application-Specific Integrated Circuit (ASIC), but is not limited thereto. The storage circuit 160 may be a Subscriber Identity Module (SIM), a Read-Only Memory (ROM), a Flash memory, or a Random Access Memory (Random-Access Memory), RAM), disc read-only memory (CD-ROM/DVD-ROM/BD-ROM), magnetic tape, hard disk, optical data storage device, Non-volatile storage device, non-transitory computer-readable medium, but is not limited thereto.

Furthermore, please refer to FIG. 2, which is a schematic diagram of a data padding method 20 according to an embodiment of the present invention. The data padding method 20 may be compiled into a program code, which is executed by the processing circuit 150 of FIG. 1 and is stored in the storage circuit 160. The data padding method 20 includes steps as follows:

Step S200: Start.

Step S202: Add at least one padding column or at least one padding row to a data matrix, wherein one of a plurality of elements of the at least one padding column or the at least one padding row is different from another of the plurality of elements.

Step S204: End.

In short, in order to improve inference accuracy, the embodiment of the present invention adds at least one padding column or at least one padding row to a data matrix, and hence substantially increases a total column number or a total row number to prevent Convolutional Neural Networks (CNN) from learning fewer features or learning wrong features.

Specifically, please refer to FIG. 3, which is a schematic diagram of a data matrix 310, padding columns 310LT1, 310RT1, padding rows 310TF1, 310BF1 and convolution operation thereof according to an embodiment of the present invention. As shown in FIG. 3, the data matrix 310 includes elements M11 to M88 arranged in 8 columns and 8 rows. The padding column 310LT1 includes elements LT11 to LT81 arranged in 1 column and 8 rows. The padding column 310RT1 includes elements RT11 to RT81 arranged in 1 column and 8 rows. The padding row 310TF1 includes elements TF11 to TF110 arranged in 10 columns and 1 row. The padding row 310BF1 includes elements BF11 to BF110 arranged in 10 columns and 1 row. As shown in FIG. 3, after the padding columns 310LT1, 310RT1 and the padding rows 310TF1, 310BF1 are added to the data matrix 310, a total column number increases to 10, and a total row number increases to 10. As a result, the total column number or the total row number substantially increases. The total column number (namely, 10 columns as shown in FIG. 3) is equal to a sum of a column number of the data matrix 310 (namely, 8 columns as shown in FIG. 3) and column numbers of the padding columns 310LT1, 310RT1 (namely, 2 columns as shown in FIG. 3 respectively). The total row number (namely, 10 rows as shown in FIG. 3) is equal to row numbers of the data matrix 310 (namely, 8 rows as shown in FIG. 3) and a row number of the padding rows 310TF1, 310BF1 (namely, 2 rows as shown in FIG. 3 respectively). It is noteworthy that FIG. 3 only illustrates 2 padding columns (namely, the padding columns 310LT1, 310RT1) and 2 padding rows (namely, the padding rows 310TF1, 310BF1); however, numbers of padding columns and padding rows may be adjusted according to different requirements.

In order to extract features of the data matrix 310, convolution layer output 330 may be obtained by means of convolution (operation). Convolution operation is a linear operation involving computations between the data matrix 310 and convolution kernel 320. In some embodiments, the convolution kernel 320 may serve as a set of weights. Combination of the padding columns 310LT1, 310RT1, the padding rows 310TF1, 310BF1 and the data matrix 310 may be divided into a plurality of patches 310P. Each patch 310P has the same size as the convolution kernel 320. Each patch 310P may be taken dot product with the convolution kernel 320 respectively. That is to say, each element in the patch 310P is taken element-wise multiplication with each element in the convolution kernel 320. The element-wise multiplication between the patch 310P and the convolution kernel 320 is then summed, which results in a single value. For example, a patch 310P may include elements M23 to M25, M33 to M35, and M43 to M45 of data matrix 310. The convolution kernel 320 may include elements K11 to K33. The convolution layer output 330 may include elements C11 to C88. The elements M23 to M25, M33 to M35, and M43 to M45 are taken element-wise multiplication with the corresponding elements K11 to K33. The element-wise multiplication between the patch 310P and the convolution kernel 320 is then summed to obtain the element C34 of the convolution layer output 330. Alternatively, a patch 310P may include elements TF11 to TF13, LT11 to LT21, M11 to M12, and M21 to M22. The elements TF11 to TF13, LT11 to LT21, M11 to M12, and M21 to M22 are taken element-wise multiplication with the corresponding elements K11 to K33. The element-wise multiplication between the patch 310P and the convolution kernel 320 is then summed to obtain the element C11 of the convolution layer output 330. By applying the convolution kernel 320 to each of patches 310P, the two-dimensional convolution layer output 330 may be obtained. In some embodiments, the convolution layer output 330 may serve as a features map.

In some embodiments, the size of the convolution kernel 320 is smaller than the size of the data matrix 310. In some embodiments, the size of the convolution kernel 320 maybe any combination of j×i, where i and j are odd numbers such as 1, 3, 5, 7, 9 respectively. For example, as shown in FIG. 3, the data matrix 310 includes 8 columns and 8 rows of elements M11 to M88, so the size of the data matrix 310 is 8×8. The convolution kernel 320 includes elements K11 to K33 arranged in 3 columns and 3 rows; therefore, a (convolution kernel) size of the convolution kernel 320 is 3×3. Besides, as shown in FIG. 3, the convolution layer output 330 includes elements C11 to C88 arranged in 8 columns and 8 rows, and thus the size of the convolution layer output 330 is 8×8. That is to say, the size of the convolution layer output 330 is equal to the size of the data matrix 310. As a result, the present invention may prevent the convolutional neural network from learning fewer features. Obviously, if the padding columns 310LT1, 310RT1 and the padding rows 310TF1, 310BF1 are not added to the data matrix 310, the size of the convolution layer output 330 is equal to 6×6, which is smaller than the size of the data matrix 310. In such a situation, the convolutional neural network would learn fewer features or insufficient features. As can be seen from the above, in order to ensure the size of the convolution layer output 330 equal to the size of the data matrix 310, the data padding method 20 are required, and adding the padding columns 310LT1, 310RT1 and the padding rows 310TF1, 310BF1 to the data matrix 310 are necessary. In other words, the column numbers of the padding columns 310LT1, 310RT1 and the row numbers of the padding rows 310TF1, 310BF1 are adaptively coordinated with the column number and the row number of the data matrix 310 to make the total column number and the total row number reach a target column number and a target row number respectively. Consequently, the size of the convolution layer output 330 increases, thereby preventing convolutional neural network from learning fewer features.

In order to prevent convolutional neural network from learning wrong features, in some embodiments, the data padding method 20 is related to the type of the data matrix 310 or the manner in which the data matrix 310 is obtained. For example, in some embodiments, the data matrix 310 is a spectrogram, and the data matrix 310 is obtained by converting an audio waveform. In such a situation, the elements LT11 to LT81, RT11 to RT81 of the padding columns 310LT1, and 310RT1 may also be obtained from an audio waveform. One of the elements LT11 to LT81, RT11 to RT81 of the padding columns 310LT1, and 310RT1 is different from another of the elements LT11 to LT81, RT11 to RT81. For example, a value of the element LT11 is different from a value of the element LT81. Alternatively, a value of the element RT11 is different from a value of the element LT81. Specifically, please refer to FIG. 4, which is a schematic diagram of conversion of an audio data 410 and padding data 410LT1, 410RT1 into the data matrix 310 and the padding columns 310LT1, 310RT1 as shown in FIG. 3 according to an embodiment of the present invention. As shown in FIG. 4, an original audio signal 400 is an audio waveform, and includes a plurality of segmental audio data (for example, segmental audio data 410T1 to 410T8) corresponding to time segments LT3 to LT1, T1 to T8, RT1 to RT8. A time interval dt of each of the time segments LT3 to LT1, T1 to T8, RT1 to RT8 is the same as another, and thus each segmental audio data corresponds to the same time interval dt. The audio data 410 includes the segmental audio data 410T1 to 410T8 corresponding to the time segments T1 to T8. The padding data 410LT1, 410RT1 include segmental audio data corresponding to the time segments LT1, RT1, respectively. The time segments T1 to T8, LT1, and RT1 are continuous time segments, and are adjacent in time domain and space domain. That is to say, the time segments T1 to T8 (also referred to as a first time segment) corresponding to the data matrix are adjacent to the time segments LT1, RT1 (also be referred to as second time segments) corresponding to the padding columns 310LT1, 310RT1. Therefore, there is physically meaningful association between the audio data 410 and the padding data 410LT1, 410RT1.

In short, the audio data 410 may be extracted from the audio signal 400, and the audio data 410 shown in FIG. 4 may be converted to the data matrix 310 shown in FIG. 3. Similarly, the padding data 410LT1, 410RT1 may be extracted from the audio signal 400, and the padding data 410LT1, 410RT1 shown in FIG. 4 may be converted to the padding columns 310LT1, 310RT1 shown in FIG. 3. Adding the padding columns 310LT1, 310RT1 to data matrix 310 may substantially increase the total column number so as to prevent the convolutional neural network from learning fewer features, thereby improving inference accuracy. By converting the audio data 410 and the padding data 410LT1, 410RT1 of physically meaningful association into the data matrix 310 and the padding columns 310LT1, 310RT1, the convolutional neural network may not learn wrong features, and the inference accuracy may be further improved.

Specifically, the padding data 410LT1, 410RT1 may be converted to the padding columns 310LT1, 310RT1 according to the manner in which the audio data 410 is converted to the data matrix 310. In some embodiments, the audio data 410 is a one-dimensional time domain signal, and the data matrix 310 is a two-dimensional time domain frequency domain data that reflects frequency content over time. Similarly, the padding data 410LT1, 410RT1 are time domain signals; the padding columns 310LT1, 310RT1 are time domain frequency domain data. In some embodiments, the audio data 410 is an audio waveform, and the data matrix 310 is a spectrogram. In some embodiments, the padding data 410LT1, 410RT1 are audio waveforms, and the padding columns 310LT1, 310RT1 are spectrograms. In such a situation, as shown in FIG. 4, the audio data 410 may be framed or segmented, meaning that the audio data 410 is split or divided into a series of the segmental audio data 410T1 to 410T8 corresponding to the time segments T1 to T8. In some embodiments, the segmental audio data 410T1 to 410T8 may also be windowed. In some embodiments, Fourier transform may be performed on the segmental audio data 410T1 to 410T8 corresponding to the time segments T1 to T8 to obtain frequency spectrums 310T1 to 310T8 corresponding to the time segments T1 to T8 and distributed in frequencies F1 to F8. In some embodiments, the frequency spectrums 310T1 to 310T8 may be further processed to obtain a corresponding Mel spectrogram. The two-dimensional data matrix 310 may be produced by rotating and stacking the frequency spectrums 310T1 to 310T8 side-by-side. The two-dimensional data matrix 310 reflects frequency domain data varying with time. Similarly, the padding data 410LT1, 410RT1 may be framed, windowed, and subjected to Fourier transform into frequency spectrums to form the padding columns 310LT1, 310RT1. The padding columns 310LT1, 310RT1 reflects frequency domain data varying with time. That is to say, in some embodiments, conversions of the data matrix 310 and the padding columns 310LT1, 310RT1 are performed together; namely, time domain frequency domain transformation corresponding to the data matrix 310 and time domain frequency domain transformation corresponding to the padding columns 310LT1, 310RT1 are performed together. In other words, the audio data 410 and the padding data 410LT1, 410RT1 experience time domain frequency domain transformation together to generate the data matrix 310 and the padding columns 310LT1, 310RT1. However, in some embodiments, parameters of processing procedure such as framing, windowing, and Fourier transform to extracted the audio data 410 alone from the audio signal 400 are different from parameters of processing procedure such as framing, windowing, and Fourier transform to extracted the audio data 410 and the padding data 410LT1, 410RT1 together from the audio signal 400. That is to say, the parameters of the processing procedures such as framing, windowing, and Fourier transform are adjusted according to the addition of the padding data 410LT1, 410RT1 further.

It is noteworthy that the aforementioned description is an exemplary embodiment of the present invention, and those skilled in the art may readily make different alternations and modifications. For example, step S202 of the data padding method 20 may include following steps:

Step S402: Determine a time interval dt corresponding to each of at least one padding column (for instance, the padding columns 310LT1, 310RT1).

Step S404: Determine a column number (for instance, 2 columns) of the at least one padding column.

Step S406: Determine a total time length to be extracted from the audio signal 400, wherein the total time length is equal to a sum of a time length TLTH1 of the audio data 410 and the column number of the at least one padding column multiplied by the time interval dt.

Step S408: Convert the audio data 410 and the at least one padding data (for instance, the padding data 410LT1, 410RT1) extracted from the audio signal 400 into the data matrix 310 and the at least one padding column respectively, wherein a second time length of all of the at least one padding data is equal to the column number of the at least one padding column multiplied by the time interval dt respectively.

In step S402, in some embodiments, since the time interval dt corresponding to each segmental audio data is the same as another, the time interval dt corresponding to the padding data 410LT1, 410RT1 may be determined according to the time length TLTH1 (also referred to as the first time length) corresponding to the audio data 410 and the number of framing. In step S402, in some embodiments, according to a sampling rate and the time length TLTH1 of the audio data 410, a relationship between the time length TLTH1 of the audio data 410 and the number of elements of the data matrix 310 in a direction Dj may be found out (for instance, 8 elements as shown in FIG. 3). In this way, the corresponding time interval dt of one element of the data matrix 310 in the direction Dj may be calculated. Similarly, an element of a padding column (for instance, the padding column 310LT1 or the padding column 310RT1) also corresponds to the time interval dt in the direction Dj. Because one padding column (for instance, the padding column 310LT1 or the padding column 310RT1) has 1 column and 8 rows, each padding column corresponds to the time interval dt respectively.

Instep S404, the number of padding columns must be determined. In some embodiments, a stride column number is a ratio between the data matrix 310 and the convolution layer output 330. In some embodiments, the column number of the data matrix 310 is W, the column number of the convolution kernel 320 is Kj, and the stride column number is S. In order to maintain the sizes of the data matrix 310 and the convolution layer output 330 equal or proportional, the column number of the padding column to be added on one side is Pj, where Pj=0.5*(Kj−1). For example, as shown in FIG. 3, the data matrix 310 has 8 columns, the convolution kernel 320 has 3 columns, and the stride column number is 1, such that the number of padding columns is 2. In other words, the number of padding columns to be added on one side is 1. Therefore, one padding column (for instance, the padding columns 310LT1, 310RT1 as shown in FIG. 3) is required to be added to the left side and the right side of the data matrix 310 respectively.

In step S406, the total time length to be extracted from the original audio signal 400 is determined, wherein the total time length is equal to the time length TLTH1 of the audio data 410 plus the number of padding columns multiplied by the time interval dt. That is to say, according to the number of padding columns, the total time length that should be extracted from the original audio signal 400 may be calculated, and a time length tj of padding data on one side may be calculated, where tj=Pj*dt. For example, in order to increase the total column number, one padding column (for instance, the padding column 310LT1 or 310RT1 as shown in FIG. 3) is added to the left side and the right side of the data matrix 310, respectively. In other words, the number of padding columns is 2. Each padding column corresponds to the time interval dt, respectively. In such a situation, the audio data 410 having the time length TLTH1 and the two segmental audio data (namely, the padding data 410LT1, 410RT1) corresponding to the time interval dt, respectively, should be extracted from the original audio signal 400. In step S408, the audio data 410 and the padding data 410LT1, 410RT1 extracted from the original audio signal 400 are converted into the data matrix 310 and the padding columns 310LT1, 310RT1 respectively. As a result, the padding columns 310LT1, 310RT1 may be added to the data matrix 310. As may be seen from the above, the padding data 410LT1, 410RT1 corresponding to the padding columns 310LT1, 310RT1 are added to the audio data 410 before the audio data 410 is converted to the data matrix 310.

That is to say, more padding data (for instance, the padding data 410LT1, 410RT1) are extracted from the original audio signal 400. According to the manner in which the audio data 410 is converted to the data matrix 310, the padding data 410LT1, 410RT1 physically meaningfully associated with the audio data 410 are converted into the padding columns 310LT1, 310RT1. The padding columns 310LT1, 310RT1 are then added to the data matrix 310. As a result, the present invention substantially increases the total column number to prevent convolutional neural network from learning fewer features or learning wrong features, thereby improving inference accuracy.

It is noteworthy that the present invention is not limited to these, and extraction of multiple audio data and padding data may be overlapped. In some embodiments, please refer to FIG. 5, which is a schematic diagram of an audio data 510, padding data 510LT1, 510RT1, and the audio data 410 and the padding data 410LT1, 410RT1 shown in FIG. 4 according to an embodiment of the present invention. The structure of the audio data 510 is similar to that of the audio data 410, and the structure of the padding data 510LT1, 510RT1 is similar to that of the padding data 410LT1, 410RT1. Differences lie in that the audio data 410 corresponds to the time segments T1 to T8, and that the audio data 510 corresponds to time segments RT1 to RT8. The padding data 410LT1, 410RT1 corresponds to the time segments LT1, RT1, and the padding data 510LT1, 510RT1 corresponds to time segments T8, RT9. As shown in FIG. 5, the audio data 410 is partially overlapped with the padding data 510LT1, and the audio data 510 is partially overlapped with the padding data 410RT1.

Besides, extraction of the audio data 410 maybe appropriately adjusted. For example, in some embodiments, please refer to FIG. 6, which is a schematic diagram of an audio data 610 and the audio data 410 and the padding data 410LT1, 410RT1 shown in FIG. 4 according to an embodiment of the present invention. The structure of the audio data 610 is similar to that of the audio data 410. Differences lie in that the audio data 610 alone is extracted from the original audio signal 400. Compared with the audio data 610 separately/solely extracted from the audio signal 400, when the audio data 410 and the padding data 410LT1, 410RT1 are extracted together from the audio signal 400, the audio data 410 is another audio data with the time length TLTH1 re-extracted from the audio signal 400, and the audio data 410 is different from the audio data 610. In some embodiments, the audio data 410 may be obtained by shifting the audio data 610; for example, the audio data 610 is shifted/offset along the time axis according to the time interval dt.

In order to prevent the convolutional neural network from learning wrong features, in some embodiments, the data padding method 20 maybe adaptively adjusted according to the type of the data matrix 310 or the manner in which the data matrix 310 is obtained. For example, please refer to FIG. 7, which is a schematic diagram of conversion of the audio data 410 shown in FIG. 4 into the data matrix 310 shown in FIG. 3 and a padding row 710TF1 according to an embodiment of the present invention. The structure of the padding row 710TF1 is similar to the padding row 310TF1 shown in FIG. 3. Distinct from the padding row 310TF1 shown in FIG. 3, the padding row 710TF1 includes elements TF12 to TF19 arranged in only 8 columns and 1 row. As shown in FIG. 7, the audio data 410 includes the segmental audio data 410T1 to 410T8 corresponding to the time segments T1 to T8. In some embodiments, the segmental audio data 410T1 to 410T8 may be sampled with a first sampling frequency. When the first sampling frequency is higher, a waveform of a digital signal is closer to a waveform of an analog signal, resulting in better sampling quality. Therefore, a first highest frequency (namely, the Nyquist frequency) corresponding to the segmental audio data 410T1 to 410T8 is one-half of the first sampling frequency. The Nyquist frequency involves a frequency span of the Fourier transform and thus relates to the frequency span of the Fourier transform. For example, the Fourier transform between the segmental audio data 410T1 to 410T8 and the data matrix 310 may correspond to the first sampling frequency, and thus the frequency span of the Fourier transform corresponds to the first highest frequency. In some embodiments, the segmental audio data 410T1 to 410T8 may be sampled with a second sampling frequency and involves upsampling (also referred to as raising frequency). A second highest frequency (namely, the Nyquist frequency) corresponding to the segmental audio data 410T1 to 410T8 is one-half of the second sampling frequency. For example, the Fourier transform between the segmental audio data 410T1 to 410T8 and the padding row 710TF1 may correspond to the second sampling frequency, and thus the frequency span of the Fourier transform corresponds to the second highest frequency. As can be seen from the above, there is physically meaningful association between the data matrix 310 and the padding row 710TF1.

In short, the audio data 410 may be converted to the data matrix 310, which corresponds to the time segments T1 to T8 and is distributed in the frequencies F1 to F8, according to the first sampling frequency, and may be converted to the padding row 710TF1, which corresponds to the segments T1 to T8 and is distributed in the frequency TF1, according to the second sampling frequency as well. Adding the padding row 710TF1 to the data matrix 310 may substantially increase the total row number in order to prevent the convolutional neural network from learning fewer features, thereby improving inference accuracy. Adding the padding row 710TF1 having physically meaningful association with the data matrix 310 to the data matrix 310 may avoid convolutional neural network from learning wrong features, thereby improving inference accuracy further.

Specifically, the step S202 of the data padding method 20 includes steps as follows:

Step S702: Calculate at least one padding row frequency corresponding to at least one padding row, wherein the at least one padding row frequency is related a first highest frequency and a second frequency resolution.

Step S704: Calculate the at least one padding row according to the at least one padding row frequency corresponding to the at least one padding row.

In step S702, the padding row frequency corresponding to the padding row 710TF1 may be calculated. In some embodiments, the frequency TF1 (also referred to as a padding row frequency) corresponding to the padding row 710TF1 complies with TF1=res2*(ROUNDDOWN(fmax1/res2,0)+1), where fmax1 is the first highest frequency, res2 is the second frequency resolution, and ROUNDDOWN(x,0) represents unconditionally rounding a number x down to zero decimal places. However, the present invention is not limited to these. For example, the number of padding rows may be adjusted according to different requirements. The padding row frequency corresponding to another padding row may be TFn, wherein TFn=res2*(ROUNDDOWN(fmax1/res2,0)+n), and n is a positive integer. As can be seen from the above, the padding row frequencies (namely, TF1 to TFn) are greater than the first highest frequency.

In some embodiments, the first highest frequency corresponding to the segmental audio data 410T1 to 410T8 is one-half of the first sampling frequency (namely, fmax1=0.5*fs1). Here, fs1 is the first sampling frequency with which the segmental audio data 410T1 to 410T8 are sampled. In some embodiments, the first frequency resolution corresponding to the segmental audio data 410T1 to 410T8 is res1, wherein res1=fs1/bin1, and bin1 is a frequency bin corresponding to the segmental audio data 410T1 to 410T8. For example, the first sampling frequency may be fs1=32 kHz, and the first highest frequency is fmax1=0.5*32 kHz=16 kHz. In FIG. 7, the segmental audio data 410T1 to 410T8 are subjected to Fourier transform to obtain frequency spectrums 310T1 to 310T8 distributed over 8 frequencies F1 to F8, respectively. However, the present invention is not limited to these, and may be distributed over 256 frequencies after Fourier transform. If divided into 256 equal parts (namely, bin1=256), the first frequency resolution is res1=32 kHz/256=125 Hz. Similarly, in some embodiments, the second highest frequency corresponding to the segmental audio data 410T1 to 410T8 is one-half of the second sampling frequency, (namely, fmax2=0.5*fs2). Here, fs2 is the second sampling frequency with which the segmental audio data 410T1 to 410T8 is sampled. In some embodiments, the second frequency resolution corresponding to the segmental audio data 410T1 to 410T8 is res2, where res2=fs2/bin2, and bin2 is another frequency bin corresponding to the segmental audio data 410T1 to 410T8. For example, the second sampling frequency may be fs2=44.1 kHz and the second highest frequency is fmax2=0.5*44.1 kHz=22.05 kHz. Similarly, if divided into 256 equal parts (namely, bin2=256), the second frequency resolution is res2=44.1 kHz/256=172.265625 Hz. In such a situation, the padding row frequency corresponding to the padding row 710TF1 is TF1=172.265625 Hz*(ROUNDDOWN(16 kHz/172.265625 Hz, 0)+1)=172.265625 Hz*(ROUNDDOWN(92.87981859,0)+1)=172.265625 Hz*(92+1)=16.02070313 kHz.

In step S704, the padding row 710TF1 is calculated according to the padding row frequency (namely, the frequency TF1) corresponding to the padding row 710TF1. Alternatively, other padding rows are calculated according to padding row frequencies (for instance, TFn) corresponding to the other padding rows. As a result, the padding row 710TF1 may be added to the data matrix 310. In such a situation, one of the elements TF12 to TF19 of the padding row 710TF1 is different from another of the elements TF12 to TF19; for instance, the value of the element TF12 is not equivalent to the value of the element TF19. As can be seen from the above, the padding row 710TF1 converted from the audio data 410 is added to the audio data 410 after the audio data 410 is converted into the data matrix 310. Accordingly, the present invention may raise frequency to perform padding, and the bandwidth of the data matrix 310 may be extended by the second frequency resolution by means of upsampling. Therefore, the padding row 710TF1 added to the data matrix 310 has physically meaningful association with the data matrix 310 so as to prevent convolutional neural network from learning wrong features, thereby improving inference accuracy.

In addition, the present invention may add at least one padding column and at least one padding row together to the data matrix 310. For example, please refer to FIG. 8, which is a schematic diagram of conversion of the audio data 410 shown in FIG. 4 into the data matrix 310 shown in FIG. 3 and the padding row 310TF1 according to an embodiment of the present invention. The structure of the padding row 310TF1 shown in FIG. 8 is similar to the padding row 710TF1 shown in FIG. 7, and one of elements TF11 to TF110 of the padding column 310TF1 is different from another of the elements TF11 to TF110. For example, the value of the element TF12 is different from the value of the element TF19. Distinct from the padding row 710TF1 shown in FIG. 7, the padding row 310TF1 includes the elements TF11 to TF110 arranged in 10 columns and 1 row. As shown in FIG. 8, the audio data 410 and the padding data 410LT1, 410RT1 may be converted into the data matrix 310 according to the first sampling frequency, or may be converted into the padding row 310TF1 according to the second sampling frequency. Adding the padding row 310TF1 to the data matrix 310 may substantially increase the total row number to prevent convolutional neural network from learning fewer features, thereby improving inference accuracy. Adding the padding row 310TF1 having physically meaningful association with the data matrix 310 to the data matrix 310 may prevent convolutional neural network from learning wrong features, and hence improve the inference accuracy hence.

In order to prevent convolutional neural network from learning wrong features, in some embodiments, the data padding method 20 may be adaptively adjusted according to the type of the data matrix 310 or the manner in which the data matrix 310 is obtained. For example, please refer to FIG. 9, which is a schematic diagram of conversion of the audio data 410 shown in FIG. 4 into the data array 310 shown in FIG. 3 and a padding row 910BF1 according to an embodiment of the present invention. The structure of the padding row 910BF1 is similar to the padding row 310BF1 shown in FIG. 3. Distinct from the padding row 310TF1 shown in FIG. 3, the padding row 910BF1 includes elements BF12 to BF19 arranged in only 8 columns and 1 row. As shown in FIG. 9, the audio data 410 includes the segmental audio data 410T1 to 410T8 corresponding to the time segments T1 to T8. In some embodiments, the segmental audio data 410T1 to 410T8 may be converted into the data matrix 310, and may also be converted into the padding row 910BF1 by means of downsampling (also referred to as reducing frequency). As may be seen from the above, there is physically meaningful association between the data matrix 310 and the padding row 910BF1.

In short, the audio data 410 may be converted into the data matrix 310, which corresponds to the time segments T1 to T8 and is distributed in the frequencies F1 to F8, and may also be converted to the padding row 910BF1, which corresponds to the segments T1 to T8 and is distributed in the frequency BF1 by means of reducing frequency. Adding the padding row 910BF1 to the data matrix 310 may substantially increase the total row number in order to prevent convolutional neural network from learning fewer features, thereby improving inference accuracy. Adding the padding row 910BF1 having physically meaningful association with the data matrix 310 to the data matrix 310 may prevent convolutional neural network from learning wrong features, thereby improving inference accuracy further.

Specifically, the step S202 of the data padding method 20 may include steps as follows:

Step S902: Calculate at least one padding row frequency corresponding to at least one padding row, wherein the at least one padding row frequency is related to a first lowest frequency, a first frequency resolution and a ratio coefficient.

Step S904: Calculate the at least one padding row according to the at least one padding row frequency corresponding to the at least one padding row.

In step S902, the padding row frequency corresponding to the padding row 910BF1 may be calculated. In some embodiments, the frequency BF1 (also referred to as a padding row frequency) corresponding to the padding row 910BF1 complies with BF1=fmin1−1*(res1/fac), where fmin1 is the first lowest frequency, res1 is the first frequency resolution, and fac is the ratio coefficient. However, the present invention is not limited to these. For example, the number of padding rows may be adjusted according to different requirements. The padding row frequency corresponding to another padding row may be BFn, where BFn=fmin1−n*(res1/fac), and n is a positive integer. As can be seen from the above, the padding row frequencies (namely, BF1 to BFn) are smaller than the first lowest frequency.

In some embodiments, the first sampling frequency with which the segmental audio data 410T1 to 410T8 are sampled is fs1. In some embodiments, the first frequency resolution corresponding to the segmental audio data 410T1 to 410T8 is res1, where res1=fs1/bin1, and bin1 is a frequency bin corresponding to the segmental audio data 410T1 to 410T8. In some embodiments, the first lowest frequency corresponding to the segmental audio data 410T1 to 410T8 may be equal to the first frequency resolution (namely, fmin1=res1). For example, the first sampling frequency may be fs1=32 kHz. In the FIG. 9, the segmental audio data 410T1 to 410T8 are subjected to Fourier transform to obtain the frequency spectrums 310T1 to 310T8 distributed over the 8 frequencies F1 to F8, respectively. However, the present invention is not limited to these, and may be distributed over 256 frequencies after the Fourier transform. If divided into 256 equal parts (namely, bin1=256), the first frequency resolution is res1=32 kHz/256=125 Hz, and the first lowest frequency is also fmin1=125 Hz. In such a situation, the frequency BF1 corresponding to the padding row 910BF1 complies with BF1=125 Hz-(125 Hz/fac).

In some embodiments, fac is a ratio coefficient related to Pi, and Pi is the row number of padding rows that need to be added on one side. In some embodiments, Pi=0.5*(Ki−1), and Ki is the row number of the convolution kernel 320. In some embodiments, fac=log2(Pi+1). In such a situation, the padding row frequency may be fmin1−1*(res1/fac), fmin1−2*(res1/fac), . . . , fmin1−n*(res1/fac), and n=Pi. In some embodiments, Pi<2^{fac}−1. In such a situation, the padding row frequency may be one or more of fmin1−1*(res1/fac), fmin1−2*(res1/fac), . . . , fmin1−Pi*(res1/fac).

In step S904, the padding row 910BF1 is calculated according to the padding row frequency (namely, the frequency BF1) corresponding to the padding row 910BF1. Alternatively, other padding rows are calculated according to padding row frequencies (for instance, BFn) corresponding to other padding rows. As a result, the padding row 910BF1 may be added to the data matrix 310. In such a situation, one of the elements BF12 to BF19 of the padding row 910BF1 is different from another of the elements BF12 to BF19; for example, the value of the element BF12 is not equivalent to the value of the element BF19. As can be seen from the above, the padding row 910BF1 converted from the audio data 410 is added to the audio data 410 after the audio data 410 is converted into the data matrix 310. Accordingly, the present invention may reduce frequency to perform padding. By means of downsampling, the lowest bandwidth of the data matrix 310 may be extended, such that the padding row 910BF1 added to the data matrix 310 has physically meaningful association with the data matrix 310 in order to ensure that the first frequency resolution and the row number after convolution remain unchanged. Therefore, the present invention prevents convolutional neural network from learning wrong features so as to improve inference accuracy without increasing the size or depth of the neural network, thereby further avoid decline in inference performance.

In addition, the present invention may add at least one padding column and at least one padding row together to the data matrix 310. For example, please refer to FIG. 10, which is a schematic diagram of conversion of the audio data 410 shown in FIG. 4 into the data matrix 310 shown in FIG. 3 and the padding row 310BF1 according to an embodiment of the present invention. The structure of the padding row 310BF1 shown in FIG. 10 is similar to the padding row 910BF1 shown in FIG. 9, and one of the elements BF11 to BF110 of the padding row 310BF1 is different from another of the elements BF11 to BF110. For example, the value of element BF12 is not equivalent to the value of element BF19. Distinct from the padding row 910BF1 shown in FIG. 9, the padding row 310BF1 includes the elements BF11 to BF110 arranged in 10 columns and 1 row. As shown in FIG. 10, the audio data 410 and the padding data 410LT1, 410RT1 may be converted into the data matrix 310, and may also be converted into the padding row 310BF1 by reducing frequency. Adding the padding row 310BF1 to the data matrix 310 may substantially increase the total row number to prevent convolutional neural network from learning fewer features, thereby improving inference accuracy. Adding the padding row 310BF1 having physically meaningful association with the data matrix 310 to the data matrix 310 may prevent the convolutional neural network from learning wrong features, and hence improve the inference accuracy further.

To sum up, the present invention adds at least one padding column or at least one padding row with physically meaningful association to a data matrix so as to prevent convolutional neural network from learning fewer features or learning wrong features, thereby improving inference accuracy.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data padding method, comprising:
adding at least one padding column or at least one padding row to a data matrix, wherein one of a plurality of elements of the at least one padding column or the at least one padding row is different from another of the plurality of elements.

2. The data padding method of claim 1, wherein the step of adding the at least one padding column or the at least one padding row to the data matrix comprises:
adding at least one padding data corresponding to the at least one padding column to an audio data before the audio data is converted to the data matrix.

3. The data padding method of claim 1, wherein the step of adding the at least one padding column or the at least one padding row to the data matrix comprises:
determining a time interval corresponding to each of the at least one padding column;
determining a column number of the at least one padding column;
determining a total time length, wherein the total time length is equal to a sum of a first time length of an audio data and the column number multiplied by the time interval; and
converting the audio data extracted from the audio signal and at least one padding data into the data matrix and the at least one padding column, respectively, wherein a second time length of all of the at least one padding data is equal to the column number multiplied by the time interval.

4. The data padding method of claim 1, wherein at least one padding data is converted to the at least one padding column according to a manner of converting an audio data to the data matrix.

5. The data padding method of claim 1, wherein a first time segment corresponding to the data matrix is adjacent to at least one second time segment corresponding to the at least one padding column.

6. The data padding method of claim 1, wherein the step of adding the at least one padding column or the at least one padding row to the data matrix comprises:
adding the at least one padding column converted from an audio data to the data matrix after the audio data is converted to the data matrix.

7. The data padding method of claim 1, wherein the step of adding the at least one padding column or the at least one padding row to the data matrix comprises:
converting an audio data into the data matrix with a first sampling frequency, and converting the audio data into the at least one padding row with a second sampling frequency.

8. The data padding method of claim 1, wherein the step of adding the at least one padding column or the at least one padding row to the data matrix comprises:
calculating at least one padding row frequency corresponding to the at least one padding row; and
calculating the at least one padding row according to the at least one padding row frequency corresponding to the at least one padding row.

9. The data padding method of claim 8, wherein the at least one padding row frequency is related to a first lowest frequency, a first frequency resolution and a ratio coefficient, or related to a first highest frequency and a second frequency resolution.

10. The data padding method of claim 8, wherein the at least one padding row frequency is less than a first lowest frequency or greater than a first highest frequency.

11. A data padding system, comprising:
a storage circuit, for storing an instruction, wherein the instruction comprises:
adding at least one padding column or at least one padding row to a data matrix, wherein one of a plurality of elements of the at least one padding column or the at least one padding row is different from another of the plurality of elements; and
a processing circuit, coupled to the storage circuit, for executing the instruction stored in the storage circuit.

12. The data padding system of claim 11, wherein the step of adding the at least one padding column or the at least one padding row to the data matrix comprises:
adding at least one padding data corresponding to the at least one padding column to an audio data before the audio data is converted to the data matrix.

13. The data padding system of claim 11, wherein the step of adding the at least one padding column or the at least one padding row to the data matrix comprises:
determining a time interval corresponding to each of the at least one padding column;
determining a column number of the at least one padding column;
determining a total time length, wherein the total time length is equal to a sum of a first time length of an audio data and the column number multiplied by the time interval; and
converting the audio data extracted from the audio signal and at least one padding data into the data matrix and the at least one padding column, respectively, wherein a second time length of all of the at least one padding data is equal to the column number multiplied by the time interval.

14. The data padding system of claim 11, wherein at least one padding data is converted to the at least one padding column according to a manner of converting an audio data to the data matrix.

15. The data padding system of claim 11, wherein a first time segment corresponding to the data matrix is adjacent to at least one second time segment corresponding to the at least one padding column.

16. The data padding system of claim 11, wherein the step of adding the at least one padding column or the at least one padding row to the data matrix comprises:
adding the at least one padding column converted from an audio data to the data matrix after the audio data is converted to the data matrix.

17. The data padding system of claim 11, wherein the step of adding the at least one padding column or the at least one padding row to the data matrix comprises:
converting an audio data into the data matrix with a first sampling frequency, and converting the audio data into the at least one padding row with a second sampling frequency.

18. The data padding system of claim 11, wherein the step of adding the at least one padding column or the at least one padding row to the data matrix comprises:
calculating at least one padding row frequency corresponding to the at least one padding row; and
calculating the at least one padding row according to the at least one padding row frequency corresponding to the at least one padding row.

19. The data padding system of claim 18, wherein the at least one padding row frequency is related to a first lowest frequency, a first frequency resolution and a ratio coefficient, or related to a first highest frequency and a second frequency resolution.

20. The data padding system of claim 18, wherein the at least one padding row frequency is less than a first lowest frequency or greater than a first highest frequency.
